(19) United States
(12) Patent Application Publication
(10) Pub. No.: US 2023/0326663 A1
(43) Pub. Date: Oct. 12, 2023

(54) COIL COMPONENT

(71) Applicant: SAMSUNG ELECTRO-MECHANICS CO., LTD., Suwon-si (KR)

(72) Inventors: Jae Hun KIM, Suwon-si (KR); In Young KANG, Suwon-si (KR)

(73) Assignee: SAMSUNG ELECTRO-MECHANICS CO., LTD., Suwon-si (KR)

(21) Appl. No.: 18/110,542

(22) Filed: Feb. 16, 2023

(30) Foreign Application Priority Data
Apr. 6, 2022 (KR) 10-2022-0042981

(51) Int. Cl. H01F 27/28; H01F 27/24; H01F 27/29; H01F 27/02

(52) U.S. Cl. CPC H01F 27/2828; H01F 27/24; H01F 27/292; H01F 27/022

(57) ABSTRACT

A coil component includes a body having first and second surfaces opposing each other, third and fourth surfaces opposing each other, and fifth and sixth surfaces connecting the first to fourth surfaces and including a mold portion having a core protruding from one surface and a cover portion disposed on the one surface of the mold portion, a wound coil having a wound portion disposed between the mold portion and the cover portion and wound around the core, a lead-out portion disposed on a side surface of the mold portion and exposed to the sixth surface of the body, and a connection portion connecting the wound portion to the lead-out portion, and an external electrode disposed on the sixth surface of the body and connected to the lead-out portion, wherein the lead-out portion is disposed to be parallel to a winding axis of the wound portion.

### CROSS-REFERENCE TO RELATED APPLICATION(S)

The present application claims the benefit of priority to Korean Patent Application No. 10-2022-0042981 filed on Apr. 6, 2022 in the Korean Intellectual Property Office, the disclosure of which is incorporated herein by reference in its entirety.

### TECHNICAL FIELD

The present disclosure relates to a coil component.

### BACKGROUND

A magnetic mold and a wound coil may be used to manufacture a coil component.

Coil components have been required to have a reduced size and a low-profile to be installed in a limited space.

There has been demand for a coil component which may have a reduced size and a low-profile and high capacitance properties, and in which short circuits with an adjacent component may be prevented, such that integration of a coil component may be easily performed.

### SUMMARY

An aspect of the present disclosure is to provide a coil component which may have a reduced size and a low-profile while securing an effective volume, such that high capacitance properties may be implemented.

An aspect of the present disclosure is to provide a coil component in which short circuits with adjacent components may be prevented when being mounted on a printed circuit board such that integration may be easily performed.

According to an aspect of the present disclosure, a coil component includes a body having first and second surfaces opposing each other, third and fourth surfaces connecting the first and second surfaces and opposing each other, and fifth and sixth surfaces connecting the first to fourth surfaces and opposing each other and including a mold portion having a core protruding from one surface and a cover portion disposed on the one surface of the mold portion, a wound coil having a wound portion disposed between the mold portion and the cover portion and wound around the core, a lead-out portion disposed on a side surface of the mold portion and exposed to the sixth surface of the body, and a connection portion connecting the wound portion to the lead-out portion, and an external electrode disposed on the sixth surface of the body and connected to the lead-out portion, wherein the lead-out portion is disposed to be parallel to a winding axis of the wound portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to an example embodiment of the present disclosure;

FIG. 2 is a perspective diagram illustrating a lower portion of the coil component in FIG. 1;

FIG. 3 is an exploded perspective diagram illustrating the coil component in FIG. 1;

FIG. 4 is a diagram illustrating a cross-sectional diagram taken along line I-I′ in FIG. 1;

FIG. 5 is a diagram illustrating a cross-sectional diagram taken along line II-II′ in FIG. 1;

FIG. 6 is a diagram illustrating the coil component in FIG. 1 in an A direction, viewed from the side;

FIG. 7 is a diagram illustrating the coil component in FIG. 1 in a B direction, viewed from the bottom;

FIG. 8 is a diagram illustrating a mold portion of a coil component according to a second example embodiment of the present disclosure;

FIG. 9 is a diagram illustrating a coil component according to a second example embodiment of the present disclosure, corresponding to FIG. 5;

FIG. 10 is a diagram illustrating a coil component according to a third example embodiment of the present disclosure, corresponding to FIG. 4;

FIG. 11 is a diagram illustrating a distance between coil components having a U-shaped external electrode are mounted;

FIG. 12 is a diagram illustrating a distance between coil components having a L-shaped external electrode are mounted; and

FIG. 13 is a diagram illustrating a distance between coil components in which an external electrode is only disposed on a mounting surface are mounted as in the present disclosure.

### DETAILED DESCRIPTION

The terms used in the example embodiments are used to simply describe an example embodiment, and are not intended to limit the present disclosure. A singular term includes a plural form unless otherwise indicated. The terms, “include,” “comprise,” “is configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term “disposed on,” “positioned on,” and the like, may indicate that an element is positioned on or beneath an object, and does not necessarily mean that the element is positioned on the object with reference to a gravity direction.

The term “coupled to,” “combined to,” and the like, may not only indicate that elements are directly and physically in contact with each other, but also include the configuration in which the other element is interposed between the elements such that the elements are also in contact with the other component.

Sizes and thicknesses of elements illustrated in the lead-outs are indicated as examples for ease of description, and example embodiments in the present disclosure an example embodiment thereof is not limited thereto.

In the lead-outs, an L direction is a first direction or a length direction, a W direction is a second direction or a width direction, a T direction is a third direction or a thickness direction.

In the descriptions described with reference to the accompanied lead-outs, the same elements or elements corresponding to each other will be described using the same reference numerals, and overlapped descriptions will not be repeated.

In electronic devices, various types of electronic components may be used, and various types of coil components may be used between the electronic components to remove noise, or for other purposes.

In other words, in electronic devices, a power inductor, a high frequency inductor (HF inductor), a general bead, a high frequency bead (GHz bead), a common mode filter, and the like.

### First Embodiment

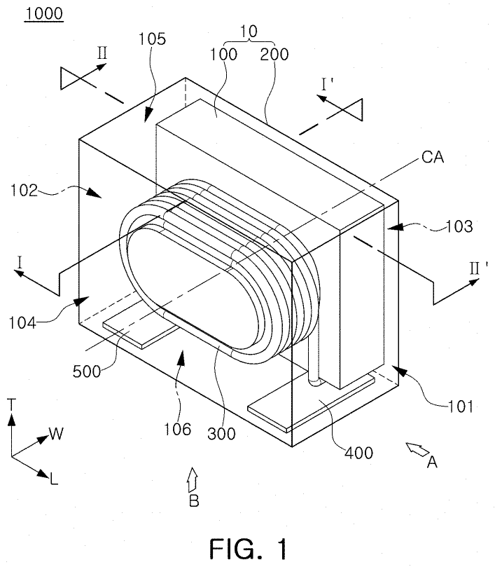

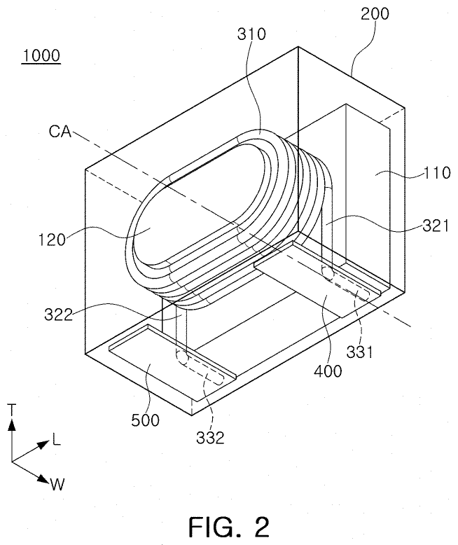

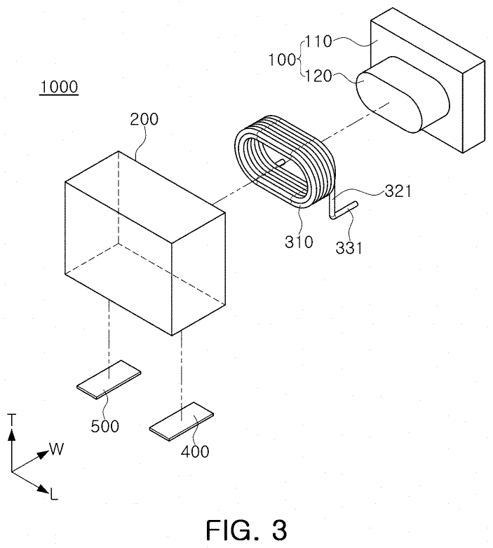

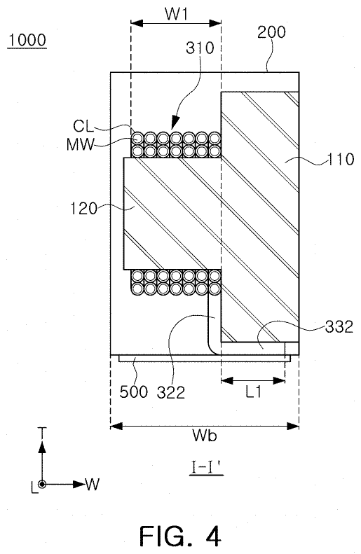

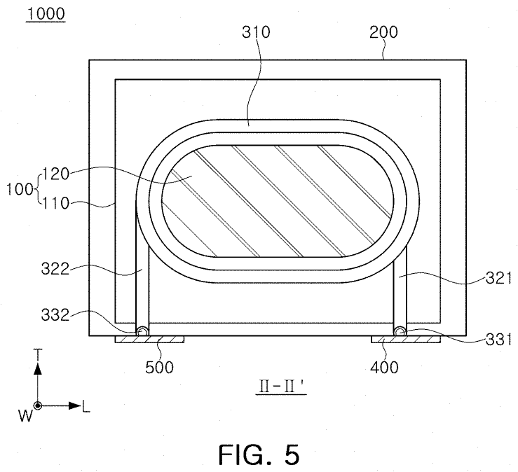

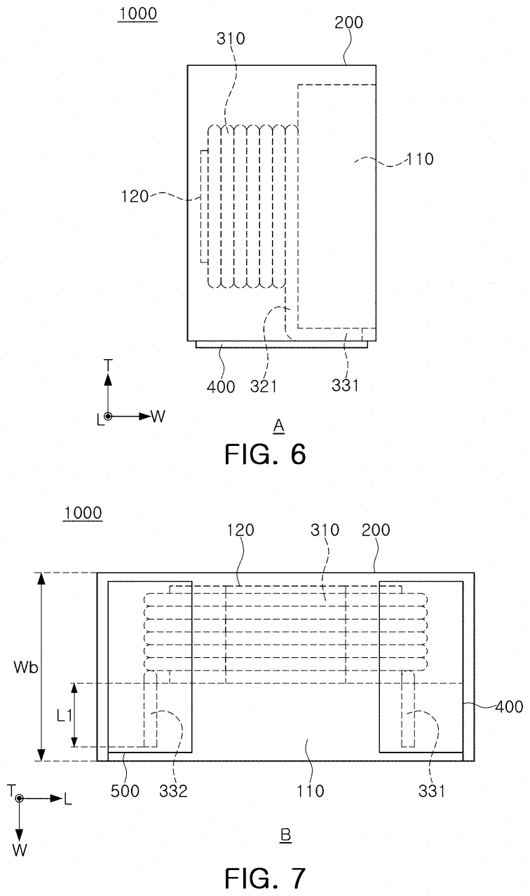

FIG. 1 is a perspective diagram illustrating a coil component 1000 according to a first example embodiment. FIG. 2 is a perspective diagram illustrating a lower portion of the coil component in FIG. 1. FIG. 3 is an exploded perspective diagram illustrating the coil component in FIG. 1. FIG. 4 is a diagram illustrating a cross-sectional diagram taken along line I-I′ in FIG. 1. FIG. 5 is a diagram illustrating a cross-sectional diagram taken along line II-II′ in FIG. 1. FIG. 6 is a diagram illustrating the coil component in FIG. 1 in an A direction, viewed from the side of the coil component. FIG. 7 is a diagram illustrating the coil component in FIG. 1 in a B direction, viewed from the bottom of the coil component.

Referring to FIGS. 1 to 7, the coil component 1000 in the first embodiment may include a body 10 having a mold portion 100 and a cover portion 200, a wound coil 300 having a wound portion 310, first and second lead-out portions 331 and 332 and first and second connection portions 321 and 322, and first and second external electrodes 400 and 500.

The body 10 may include a mold portion 100 and a cover portion 200. The mold portion 100 may include a base portion 110 and a core 120.

The body 10 may form an exterior of the coil component 1000 in the embodiment, and the wound coil 300 may be embedded in the body 10.

The body 10 may have a hexahedral shape.

The body 10 may include a first surface 101 and a second surface 102 opposing each other in the length direction L, a third surface 103 and a fourth surface 104 opposing each other in the width direction W, and a fifth surface 105 and a sixth surface 106 opposing each other in the thickness direction T, with respect to the directions in FIG. 1. Each of the first to fourth surfaces 101, 102, 103 and 104 of the body 10 may be a wall surface of the body 10 connecting the fifth surface 105 to the sixth surface 106 of the body 10. Hereinafter, both end surfaces of the body 10 may refer to the first surface 101 and the second surface 102 of the body 10, both side surfaces of the body 10 may refer to the third surface 103 and the fourth surface 104 of the body 10, and one surface and the other surface of the body 10 may refer to the sixth surface 106 and the fifth surface 105 of the body 10.

The body 10 may be formed such that the coil component in which the external electrodes 400 and 500 are formed may have a length of 0.8 mm, a width of 0.4 mm and a thickness of 0.8 mm in the coil component 1000, may have a length of 0.8 mm, a width of 0.4 mm and a thickness of 0.65 mm, may a length of 1.0 mm, a width of 0.7 mm and a thickness of 0.8 mm, may have a length of 1.0 mm, a width of 0.6 mm and a thickness of 0.8 mm, may have a length of 1.0 mm, a width of 0.5 mm and a thickness of 0.8 mm, may have a length of 1.0 mm, a width of 0.5 mm and a thickness of 0.65 mm, or may have a length of 1.0 mm, a width of 0.5 mm and a thickness of 0.6 mm, but an example embodiment thereof is not limited thereto. Since the above-described example numerical values for the length, width, and thickness of the coil component 1000 do not reflect process errors, and a numerical value in a range recognized as a process error may correspond to the above-described example numerical values.

The length of the above-described coil component 1000 may be a maximum value among dimensions of a plurality of line segments connecting two outermost boundary lines of the coil component 1000, opposing each other in the length direction L, to each other in parallel to the length direction L and spaced apart from each other in the thickness direction T, the coil component 1000 on an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other in parallel to the thickness direction T and spaced apart from each other in the length direction L, the coil component 1000 on an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the thickness direction T may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other in parallel to the width direction W and spaced apart from each other in the length direction L, the coil component 1000 on an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the thickness direction T, but an example embodiment thereof is not limited thereto.

Alternatively, each of the length, width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 10 may include a mold portion 100 and a cover portion 200 disposed on one surface of the mold portion 100.

Referring to FIGS. 1 to 3, the cover portion 200 may be disposed on one surface of the mold portion 100 and may surround entirety of surfaces other than the third surface of the mold portion 100. Accordingly, the first surface, the second surface, the fourth surface, the fifth surface, and the sixth surface 101, 102, 104, 105, and 106 of the body 10 may be formed by the cover portion 200, and the third surface 103 of the body 10 may be formed by the mold portion 100 and the cover portion 200.

That is, the side surface of the cover portion 200 may form the first surface 101, the second surface 102, the fifth surface 105, and the sixth surface 106 of the body 10. For example, the sixth surface 106 of the body 10 may include a side surface of the cover portion 200.

Also, one surface (the upper surface of the cover portion 200 with respect to the direction in FIG. 1) of the cover portion 200 may form the fourth surface 104 of the body 10, and the other surface (the lower surface of the mold portion 100 in the direction in FIG. 1) of the mold portion 100 may form the third surface 103 of the body 10. Hereinafter, the other surface of the mold portion 100 and the third surface 103 of the body 10 may be considered the same.

The mold portion 100 may have one surface and the other surface opposing each other, and a plurality of side surfaces connecting the one surface to the other surface.

The mold portion 100 may include a base portion 110 and a core 120.

The base portion 110 may support the wound coil 300.

The core 120 may protrude in the central portion of one surface of the base portion 110 by penetrating the wound coil 300. Accordingly, in the embodiments, one surface and the other surface of the mold portion 100 may be considered the same as one surface and the other surface of the base portion 110, respectively.

The thickness (the length in the W direction) of the base portion 110 may be 200 μm or more. When the thickness of the base portion 110 is less than 200 μm, it may be difficult to secure rigidity. The thickness of the core 120 may be 150 μm or more, but an example embodiment thereof is not limited thereto.

The cover portion 200 may cover the mold portion 100 and the wound coil 300. The cover portion 200 may be disposed on the base portion 110, the core 120, and the wound coil 300 of the mold portion 100, may be pressurized and may be coupled to the mold portion 100.

At least one of the mold portion 100 and the cover portion 200 may include a magnetic material. In the embodiment, both the mold portion 100 and the cover portion 200 may include a magnetic material. The mold portion 100 may be formed by filling a mold for forming the mold portion 100 with a magnetic material. Alternatively, the mold portion 100 may be formed by filling the mold with a composite material including a magnetic material and an insulating resin. A forming process of applying high temperature and high pressure to the magnetic material or composite material in the mold may be further performed, but an example embodiment thereof is not limited thereto.

The magnetic material included in the mold portion 100 or the cover portion 200 may be ferrite or a magnetic metal powder.

Ferrite powder may include at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may include at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

Each of the mold portion 100 and the cover portion 200 may include two or more types of magnetic materials. Here, the configuration in which the magnetic materials are different may indicate that the magnetic materials may be distinct from each other by one of an average diameter, composition, crystallinity, and shape.

The insulating resin may include epoxy, polyimide, liquid crystal polymer, and the like, alone or in combination, but an example embodiment thereof is not limited thereto.

The wound coil 300 may be embedded in the body 10 and may exhibit properties of the coil component. For example, when the coil component 1000 of the present embodiment is used as a power inductor, the wound coil 300 may maintain an output voltage by storing an electric field as a magnetic field and, thereby stabilizing the power of the electronic device.

The wound coil 300 may be disposed in the body 10, and the first and second lead-out portions 331 and 332 may be exposed to the surface of the body 10.

Referring to FIGS. 1 to 3, the wound coil 300 may include a wound portion 310 disposed between the mold portion 100 and the cover portion 200 and wound around the core 120, lead-out portions 331 and 332 disposed on the side surface of the body 10 and exposed to the sixth surface 106 of the body 10, and connection portions 321 and 322 connecting the wound portion 310 to the lead-out portions 331 and 332.

Referring to FIGS. 1 to 5, the wound coil 300 may be an air-core coil, and may be configured as a metal wire (MW) having a circular cross-section, or may be configured as a flat coil, but an example embodiment thereof is not limited thereto.

The wound coil 300 may be formed by winding a conductive metal, and the portion other than the portion in contact with the external electrodes 400 and 500 may be coated with an insulating coating layer (CL). Specifically, the wound coil 300 may be formed by winding a metal wire (MW) such as a copper wire (Cu-wire) including an insulating coating layer (CL) covering the surface of the metal wire and the metal wire in a spiral shape. Accordingly, the entire surface of each of the plurality of turns of the wound coil 300 may be coated with the insulating coating layer CL.

Referring to FIG. 4, the metal wire (MW) may be a conductive wire having a circular cross-section, but an example embodiment thereof is not limited thereto. When the wound coil 300 is formed of a flat wire, each turn of the wound coil 300 may have a rectangular cross-section.

The wound portion 310 may form a plurality of turns toward an external side of the body 10 taken in the width direction (W direction) of the body 10 or the thickness direction (T direction) of the body 10 from the core 120.

Referring FIGS. 1 and 2, in the coil component 1000 in the embodiment, the wound portion 310 may be disposed perpendicularly to on a mounting surface, that is, the sixth surface 106 of the body. In other words, the winding axis CA which may be the center of each turn of the wound portion 310 may be formed in parallel with the width direction (W direction).

The winding axis CA of the wound portion 310 may be perpendicular to the third surface 103 and the fourth surface 104 of the body 10, and may be disposed in parallel to the first surface 101, the second surface 102, the fifth surface 105, and the sixth surface 106 of the body 10.

Referring to FIGS. 1 to 4, the wound portion 310 may be wound in a ring shape or an oval shape, and may have a cylindrical or oval shape in which a cylindrical or oval hollow portion is formed in the center thereof. The wound portion 310 may be an air core coil, and the core 120 may be disposed in the air core of the wound portion 310.

In the coil component 1000 in the embodiment, the wound coil 300 may be wound in two layers on an internal side and an external side, such that the number of turns of the wound portion 310 may increase, and the first and second connection portions 321 and 322 and first and second the lead-out portions 331 and 332 may be disposed adjacent to the base 110, but an example embodiment thereof is not limited thereto.

Referring to FIG. 4, on a W-T cross-section perpendicular to the first direction (direction L) and passing through the center of the body 10, a ratio W1/Wb of a width W1 of the wound portion 310 in the second direction (direction W) to a width Wb of the body 10 in the second direction (direction W) may be ⅓ or more.

If the area of the core 120 is the same, the width W1 of the wound portion 310 increases as the number of turns increases, and the ratio W1/Wb of the width W1 of the wound portion 310 to the width Wb of the body 10 is ⅓ or more, inductance properties could be improved.

That is, the thickness of the cover portion 200 disposed between the wound portion 310 and the fourth surface 104 of the body 10, and when the sum of the thicknesses of the base portion 110 disposed between the wound portion 310 and the third surface 103 of the body 10 is less than ⅔ of the total width Wb of the body 10, inductance properties of the coil component 1000 may be improved.

Here, the width W1 of the wound portion 310 may mean the distance between two virtual lines on an optical microscope image or a scanning electron microscope (SEM) image of a W-T cross-section taken from the central portion of the body 10.

One virtual line is a line passing through a point closest to the third surface 103 of the body 10 among the outermost boundary lines of the wound portion 310 and parallel to the third direction (direction T), and the other virtual line is a line passing through a point closest to the fourth surface 104 of the body 10 among the outermost boundary lines of the wound portion 310 and parallel to the third direction (direction T).

The first and second connection portions 321 and 322 may extend from both ends of the wound portion 310 and may be connected to the first and second lead-out portions 331 and 332, respectively. The first and second connection portions 321 and 322 may extend along one surface of the base portion 110 of the mold portion 100, but an example embodiment thereof is not limited thereto.

The first and second connection portions 321 and 322 may be disposed in a direction perpendicular to the sixth surface 106 of the body 10. That is, the connection portions 321 and 322 may extend from the wound portion 310 toward the sixth surface 106 of the body 10 in the thickness direction (T direction) with respect to the direction in FIG. 1.

The first and second connection portions 321 and 322 may be portions other than the wound portion 310 and first and second the lead-out portions 331 and 332 among metal wires such as a metal wire MW of which a surface is coated with an insulating coating layer CL. Accordingly, a boundary may not be formed between the first and second connection portions 321 and 322 and the wound portion 310, and between the first and second connection portions 321 and 322 and the first and second lead-out portions 331 and 332, respectively, but an example embodiment thereof is not limited thereto.

Referring to FIGS. 1 to 4, the lead-out portions 331 and 332 may be disposed on a side surface of the mold portion 100 and may be exposed to the sixth surface 106 of the body 10. Specifically, the first and second lead-out portions 331 and 332 may extend from the first and second connection portions 321 and 322, respectively, and may be spaced apart from each other and may be exposed on the sixth surface 106 of the body 10 parallel to the winding axis CA of the wound portion 310.

That is, the first and second lead-out portions 331 and 332 may be disposed on one side surface of the base portion 110 of the mold portion 100, may be spaced apart from each other and may be exposed on the sixth surface 106 of the body 10, and may be connected to the first and second external electrodes 400 and 500, respectively.

Referring to FIGS. 4 and 7, the first and second lead-out portions 331 and 332 may be spaced apart from each other in the length direction (L direction), and may be disposed in a linear line form parallel to the width direction (W direction), the direction of the winding axis CA of the wound portion 310, but an example embodiment thereof is not limited thereto.

With respect to the width Wb which is a distance between the third surface 103 and the fourth surface 104 of the body 10, the ratio (L1/Wb) of length L1 of the lead-out portions 331 and 332 in contact with the external electrodes 400 and 500 may be 1/7 or more and 1/4 or less.

Here, the length L1 of the first and second lead-out portions 331 and 332 may refer to a dimension of the first and second lead-out portions 331 and 332 in the width direction (W direction) with respect to the direction in FIG. 1. Also, in the coil component 1000 in the embodiment, since the first and second external electrodes 400 and 500 are disposed only on the sixth surface 106 of the body 10, the width of the body 10 may be the same as the entire width of the coil component 1000.

For example, in the coil component 1000 in the embodiment, when the width of the side surface of the mold portion 110 is formed to have a smallest thickness, the thickness may be approximate to 100 μm. Here, to obtain an improved effect in inductance properties in the example in which the wound coil 300 has a vertical structure (a structure in which the mounting surface and the winding axis are parallel to each other) as compared to a horizontal structure (a structure in which the mounting surface and the winding axis are vertical to each other), the ratio of the length to the width of the coil component may be 1 or more, the ratio of the thickness to the width may be more than 1, and the thickness may be 0.8 mm or less.

Referring to Table 1 below, on the reference specification of the coil component 1000 in the embodiment, the largest total volume of the component under the above conditions may be the length of 1.0 mm, the width of 0.7 mm, and the width of 0.8 mm, and since the width of the side surface of the mold portion 110 may be formed to be 100 μm, the ratio L1/Wb of the length L1 of each the first and second lead parts 331 and 332 to the width Wb of the coil component 1000 may be 1/7.

Also, under the above conditions, the smallest total volume of the portion may be a length of 0.8 mm, a width of 0.4 mm, and a thickness of 0.65 mm, and the width of the side surface of the mold portion 110 may be 100 μm, such that the ratio (L1/Wb) of the lengths L1 of each of the first and second lead-out portions 331 and 332 to the width Wb of the coil component 1000 may be formed to be ¼.

Accordingly, the ratio L1/Wb of the length L1 of the lead-out portions 331 and 332 in contact with the first and second external electrodes 400 and 500, respectively, to the width Wb of the coil component 1000, which may be the width between the third and fourth surfaces 103 and 104 of the body 10 may be 1/7 or more and ¼ or less, but an example embodiment thereof is not limited thereto.

TABLE 1

| | | | | Ratio (L1/Wb) |
|---|---|---|---|---|
| | | | | of the length |
| | | | | L1 of the lead- |
| Length | Width | Thickness | Total | out portion to |
| of coil | of coil | of coil | volume | the width (Wb) |
| component | component | component | of coil | of the coil |
| L | W | T | component | component |
| (mm) | (mm) | (mm) | (mm³) | (L1/Wb) |
| 0.8 | 0.4 | 0.8 | 0.256 | 0.25 |
| 0.8 | 0.4 | 0.65 | 0.208 | 0.25 |
| 1 | 0.7 | 0.8 | 0.56 | 0.14 |
| 1 | 0.6 | 0.8 | 0.48 | 0.17 |
| 1 | 0.5 | 0.8 | 0.4 | 0.2 |
| 1 | 0.5 | 0.65 | 0.325 | 0.2 |
| 1 | 0.5 | 0.6 | 0.3 | 0.2 |

Here, the width Wb, which is a distance between the third surface 103 and the fourth surface 104 of the body 10, may be a maximum value among dimensions of a plurality of line segments connecting two outermost boundary lines of the coil component 1000, opposing each other in the width direction W, to each other in parallel to the width direction W and spaced apart from each other in the thickness direction T, the coil component 1000 on an optical microscope image or a scanning electron microscope (SEM) image with respect to a cross-section in the width direction W taken from the central portion of the coil component 1000 taken in the length direction L. Alternatively, the width Wb of the coil component 1000 may refer to a minimum value among the dimensions of the plurality of line segments described above. Alternatively, the width Wb of the coil component 1000 may refer to an arithmetic mean value of at least three or more of the dimensions of the plurality of line segments described above. Here, the plurality of line segments parallel to the width direction W may be spaced apart from each other by an equal distance in the thickness direction T, but an example embodiment thereof is not limited thereto

Also, the length L1 of the first and second lead-out portions 331 and 332 may be three or more arithmetic mean values among dimensions of a plurality of line segments connecting two outermost boundary lines of the coil component 1000, opposing each other in the with direction W, to each other in parallel to the with direction W and spaced apart from each other in the thickness direction T, the coil component 1000 on an optical microscope image or a scanning electron microscope (SEM) image with respect to a cross-section in the width direction W-thickness direction T taken from the central portion of the coil component 1000 taken in the length direction L. Here, the plurality of line segments parallel to the width direction W may be spaced apart from each other by an equal distance in the thickness direction T, but an example embodiment thereof is not limited thereto.

The first and second lead-out portions 331 and 332 may be portions remaining after forming the wound portions 310 and the first and second connection portions 321 and 322 among metal wires such as a copper wire (Cu-wire) of which surface is coated with an insulating coating layer (CL). Accordingly, a boundary may not be formed between the first and second lead-out portions 331 and 332 and the first and second connection portions 321 and 322, respectively, but an example embodiment thereof is not limited thereto.

Also, similarly to the wound portion 310, an insulating coating layer CL may be formed on the surfaces of the first and second lead-out portions 331 and 332, and the insulating coating layer CL may be removed from the portion of the first and second lead-out portions 331 and 332 exposed to the sixth surface 106 of the body 10 for conductivity with the external electrodes 400 and 500.

The insulating coating layer CL may include epoxy, polyimide, liquid crystal polymer, and the like, alone or in combination, but an example embodiment thereof is not limited thereto.

The first and second external electrodes 400 and 500 may be disposed on the sixth surface 106 of the body 10 and may be connected to the first and second lead-out portions 331 and 332 of the wound coil 300, respectively. Specifically, the first and second external electrodes 400 and 500 may be spaced apart from each other on the sixth surface 106 of the body 10, and may be connected to the first and second lead-out portions 331 and 332 of the wound coil 300, respectively.

Referring to FIGS. 6 and 7, since the sixth surface 106 of the body 10 is configured as the side surface of the cover portion 200, the first and second external electrodes 400 and 500 may be disposed to be in contact with the lead-out portions 331 and 332, respectively, and the cover portion 200.

Each of the first and second external electrodes 400 and 500 may be formed in a rectangular shape elongated in the width direction (W direction), but an example embodiment thereof is not limited thereto.

The first and second external electrodes 400 and 500 may be disposed in a direction parallel to the winding axis CA of the wound portion 310, and the first and second external electrodes 400 and 500 may be spaced apart from each other in the length direction (L direction).

Referring to FIGS. 2 and 7, the first and second external electrodes 400 and 500 may be spaced apart from the four side surfaces of the body 10, the first to fourth surfaces 101, 102, 103, and 104, by a predetermined distance, but an example embodiment thereof is not limited thereto.

Accordingly, the area required for mounting the coil component on a printed circuit board (PCB) may be reduced, and a distance between the coil components adjacent to each other may be reduced, such that short circuits in mounting may be reduced.

The first and second external electrodes 400 and 500 may be formed in a single-layer or multilayer structure. For example, the first and second external electrodes 400 and 500 may include a first conductive layer including copper (Cu), a second conductive layer disposed on the first conductive layer and including nickel (Ni), and a third conductive layer disposed on the second conductive layer and including tin (Sn). At least one of the second conductive layer and the third conductive layer may be formed to cover the first conductive layer, but an example embodiment thereof is not limited thereto. The first conductive layer may be a plating layer or a conductive resin layer formed by coating and curing a conductive resin including a conductive powder including at least one of copper (Cu) and silver (Ag) and a resin. The second and third conductive layers may be plating layers, but an example embodiment thereof is not limited thereto.

The first and second external electrodes 400 and 500 may be formed by vapor deposition and/or electroplating such as sputtering, but an example embodiment thereof is not limited thereto.

The first and second external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or an alloy thereof, but an example embodiment thereof is not limited thereto.

Although not illustrated in the drawings, the coil component 1000 in the embodiment may further include an insulating layer disposed on a region other than the region of the sixth surface 106 of the body 10 in which the external electrodes 400 and 500 are disposed. The insulating layer may be used as a plating resist in forming the external electrodes 400 and 500 by electroplating, but an example embodiment thereof is not limited thereto. Also, the insulating layer may also be disposed on at least a portion of the first to fifth surfaces 101, 102, 103, 104, and 105 of the body 10.

### Second and Third Embodiments

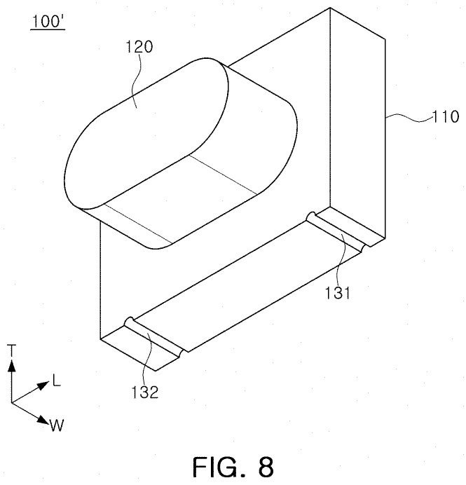

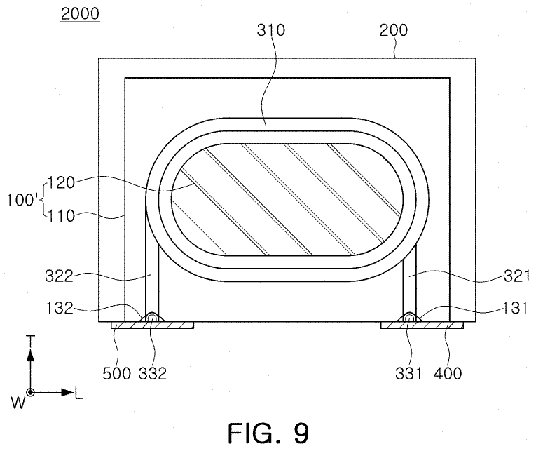

FIG. 8 is a diagram illustrating a mold portion 100′ of a coil component according to a second example embodiment. FIG. 9 is a diagram illustrating a coil component 2000 according to a second example embodiment, corresponding to FIG. 5.

Referring to FIGS. 8 and 9, in the coil component 2000 of the second example embodiment, the shape of the mold portion 100′ and the disposition of the cover portion 200 may be different from the examples in the coil component 1000 in the first embodiment. Accordingly, in describing the present embodiment, only the mold portion 100′ and the cover portion 200 different from the first embodiment will be described. For the other configuration of the present embodiment, the description in the first embodiment may be applied.

First and second groove portions 131 and 132 for accommodating the lead-out portions 331 and 332 may be formed in a portion of the side surface of the mold portion 100′ in which the first and second lead-out portions 331 and 332 are disposed.

The first and second groove portions 131 and 132 may guide the leading-out directions of the first and second lead-out portions 331 and 332, respectively, when the wound coil 300 is disposed in the mold portion 100′. Also, a portion of regions of the thicknesses of the first and second lead-out portions 331 and 332 may be accommodated in the first and second first and second groove portions 131 and 132, the size of the coil component 2000 in the thickness direction (T direction) may be reduced.

The first and second groove portions 131 and 132 may be formed on a side surface of the mold portion 100′ and may extend to one surface and the other surface of the mold portion 100′. That is, the first and second groove portions 131 and 132 may have a linear shape formed in the width direction (W direction).

The first and second groove portions 131 and 132 may be formed in a shape corresponding to the first and second lead-out portions 331 and 332, respectively. Since a portion of the lead-outs 331 and 332 are formed to protrude more than the groove portions 131 and 132, the depth of the first and second groove portions 131 and 132 may be smaller than a diameter on the cross-section of the first and second lead-outs 331 and 332, respectively.

Referring to FIG. 9, the sixth surface 106 of the body 10 may include a side surface of the mold portion 100′ and a side surface of the cover portion 200. After the first and second lead-out portions 331 and 332 are accommodated in the first and second groove portions 131 and 132, respectively, the cover portion 200 may be disposed, and the side surface of the mold portion 100′ and the side surface of the cover portion 200 may be coplanar with each other and may form the sixth surface 106 of the body 10. That is, as the first and second lead-out portions 331 and 332 are accommodated in the first and second groove portions 131 and 132, respectively, a predetermined distance between the side surface of the mold portion 100′ and the side surface of the adjacent cover portion 200 may not be essential, such that the side surface of the cover portion 200 adjacent to the side surface of the portion 100′ may be coplanar.

In this case, the first and second external electrodes 400 and 500 may be in contact with the mold portion 100′ and the cover portion 200 on the sixth surface 106 of the body 10, but an example embodiment thereof is not limited thereto.

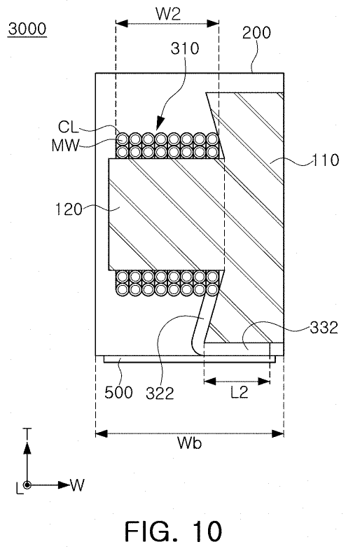

FIG. 10 is a diagram illustrating a coil component 3000 according to a third example embodiment, corresponding to FIG. 4.

Differently from FIG. 4, in the coil component 3000 in the third example embodiment, the shape of the base portion 110 of the mold portion 100, the number of turns of the wound portion 300 and the length L2 of the lead-out portion 332 may be different from the example in the coil component 1000 in the first embodiment. Accordingly, in the description of the present embodiment, only the shape of the base portion 110, the number of turns of the wound portion 300, and the length L2 of the lead-out portion 332, which are different from those of the first embodiment, will be described. For the other configuration of the present embodiment, the description in the first embodiment may be applied.

Referring to FIG. 10, the base portion 110 may have inclination on one surface in contact with the cover portion 200, and the distance between one surface and the other surfaces of the base portion 110 opposing each other may increase from the central portion of the base portion 110 toward an external side.

Specifically, one surface of the base 110 may have an inclined surface inclined toward the center of the core 120. Accordingly, the distance between the one surface and the other surface of the base portion 110, that is, the thickness of the base portion 110 in the width direction, may gradually increase from the center portion of the base portion 110 to an external side.

One surface of the base portion 110 may form a predetermined angle θ in relation to the other surface with respect to the width-thickness direction cross-section (W-T cross-section).

In the coil component 3000 in the embodiment, as the inclination is formed on the base portion 110, the wound coil 300 may be stably disposed, and the number of turns of the wound portion 310 may increase, and accordingly, inductance properties may improve.

Referring to FIG. 10, in the coil component 3000 of the third example embodiment, as the thickness of the base portion 110 decreases, the width W2 of the wound portion 310 in the second direction (direction W) may increase.

Therefore, on the W-T cross-section perpendicular to the first direction (direction L) and passing through the center of the body 10, a ratio W2/Wb of a width W2 of the wound portion 310 in the second direction (direction W) to a width Wb of the body 10 along the second direction (direction W) may greater than that of the coil component 1000 of the first example embodiment.

Also, since the length L2 and the region of the first and second lead-out portions 331 and 332 disposed along the side surface of the mold portion 100, that is, the side surface of the base portion 110, may also increase, connection reliability with the first and second external electrodes 400 and 500 or cohesion strength between the first and second lead-out portions 331 and 332 and the first and second external electrodes 400 and 500, respectively, may improve.

(Effect During Mounting and Effect of Increased Effective Volume)

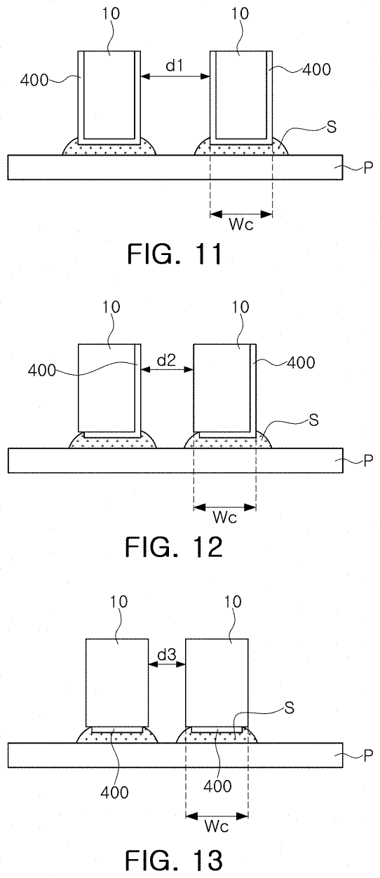

FIGS. 11 to 13 are diagrams illustrating a difference in a mounting gap according to the shape of the external electrode 400.

FIG. 11 is a diagram illustrating a distance between coil components having a U-shaped external electrode 400 are mounted. FIG. 12 is a diagram illustrating a distance between coil components having an L-shaped external electrode 400 are mounted. FIG. 13 is a diagram illustrating a distance between coil components 1000, 2000 and 3000 in which an external electrode 400 is only disposed on a mounting surface are mounted as in the present disclosure.

Referring to FIGS. 11 to 13, assuming that two coil components are mounted adjacent to each other on a printed circuit board P, when the widths We of the coil components are the same, short circuits may occur and effective volumes may be different depending on the shape of the external electrode 400.

FIG. 11 illustrates the example in which the external electrode 400 is disposed throughout three surfaces of the body 10 in a U-shape, and when the distance d1 between adjacent coil components is decreased, the distance between the external electrodes 400 may decrease, such that the risk of short circuits may increase.

Also in this case, the effective volume of the body 10 may be reduced by the volume occupied by the external electrodes 400 on both side surfaces with respect to the coil components having the same size.

FIG. 12 illustrates the example in which the external electrode 400 is disposed throughout two surfaces of the body 10 in an L-shape, and the external electrode 400 may be formed on only one side surface between coil components adjacent to each other, and the area occupied by the solder S may also be reduced. Also, since the body surface 10 and the external electrode 400 may face each other, not between the external electrodes 400, the risk of a short circuit may also be reduced, such that the distance d2 between coil components adjacent to each other may be reduced.

Also in this case, with respect to the coil component of the same size, as compared to the U-shape in which the external electrodes 400 are disposed on both side surfaces, the effective volume of the body 10 may increase by the volume occupied by the external electrodes 400 disposed on one side surface.

FIG. 13 illustrates the example in which the external electrode 400 is disposed only on the lower surface of the body 10, similarly to the coil components 1000, 2000, and 3000 in the embodiments, and since the region in which the external electrodes 400 oppose between the coil components adjacent to each other may be reduced, such that risk of short circuit may be reduced, and distance d3 may be reduced. In other words, the structure may be the most advantageous structure for integration within a mounting area of the same size.

Also, in this case, as compared to a U-shape in which the external electrodes 400 are disposed on both side surfaces, or an L-shape in which the external electrodes 400 are disposed on one side surface, the effective volume of the body 10 may increase by the volume occupied by the external electrode 400 on both side surfaces or one side surface, based on the coil components of the same size.

Referring to FIGS. 11 to 13, since the distance between adjacent components in the same mounting region may be d1>d2>d3, when the external electrodes 400 and 500 are disposed only on the lower surface of the body 10 as in the coil components 1000, 2000, and 3000 in the embodiment, the risk of a short circuit between coil components adjacent to each other may be reduced, and the effective volume may increase based on the coil components of the same size, thereby improving inductance properties.

TABLE 2

| | | | | | Ratio of | | Ratio of |
|---|---|---|---|---|---|---|---|
| | | | | Increase of | increase of | Increase of | increase of |
| | | | | effective | effective | effective | effective |
| | | | | volume when | volume when | volume when | volume when |
| | | | | external | external | external | external |
| | | | | electrode is | electrode is | electrodes are | electrodes are |
| | | | | removed from | removed from | removed from | removed from |
| | | | Total | one side | one side | both side | both side |
| L | W | T | volume | surface | surface | surfaces | surfaces |
| (mm) | (mm) | (mm) | (mm³) | (mm³) | (%) | (mm³) | (%) |
| 0.8 | 0.4 | 0.8 | 0.256 | 0.0058 | 2.27 | 0.0116 | 4.53 |
| 0.8 | 0.4 | 0.65 | 0.208 | 0.0047 | 2.26 | 0.0094 | 4.52 |
| 1 | 0.7 | 0.8 | 0.56 | 0.0072 | 1.29 | 0.0144 | 2.57 |
| 1 | 0.6 | 0.8 | 0.48 | 0.0072 | 1.50 | 0.0144 | 3.00 |
| 1 | 0.5 | 0.8 | 0.4 | 0.0072 | 1.80 | 0.0144 | 3.60 |
| 1 | 0.5 | 0.65 | 0.325 | 0.0059 | 1.82 | 0.0118 | 3.63 |
| 1 | 0.5 | 0.6 | 0.3 | 0.0054 | 1.80 | 0.0108 | 3.60 |

Referring to Table 2, as compared to the example in which the external electrode 400 is formed throughout three surfaces of the body 10 in a U-shape as illustrated in FIG. 11, the increase of the effective volume when the external electrode 400 is removed from one side surface or both side surfaces of the body 10 was confirmed.

Also, in the case of the structure in which the external electrodes 400 on both side surfaces of the body 10 are removed, that is, the structure in which the external electrodes 400 are disposed only on the lower surface of the body 10 as in the embodiments, an effective volume of 2.57% to 4.53% may be secured depending on the size of the coil component as compared to the U-shaped external electrode 400.

According to the aforementioned example embodiments, a coil component which may have a reduced size and a low-profile and may have high capacitance properties by securing an effective volume may be provided.

Also, a coil component in which short circuits between components adjacent to each other may be prevented when being mounted on a printed circuit board and may thus be easily integrated may be provided.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body having first and second surfaces opposing each other in a first direction, third and fourth surfaces connecting the first and second surfaces and opposing each other in a second direction, and fifth and sixth surfaces connecting the first to fourth surfaces and opposing each other and including a mold portion having a base portion and a core protruding from one surface of the base portion and a cover portion disposed on the one surface of the mold portion;
a wound coil having a wound portion disposed between the mold portion and the cover portion and wound around the core, a lead-out portion disposed on a side surface of the mold portion and exposed to the sixth surface of the body, and a connection portion connecting the wound portion to the lead-out portion; and
an external electrode disposed on the sixth surface of the body and connected to the lead-out portion,
wherein the lead-out portion extends from the connection portion in a direction parallel to a winding axis of the wound portion.

2. The coil component of claim 1, wherein the connection portion extends from the wound portion in a direction perpendicular to the sixth surface of the body, and the lead-out portion is connected to the external electrode.

3. The coil component of claim 1, wherein the external electrode is in contact with side surfaces of the lead-out portion and the cover portion.

4. The coil component of claim 1, wherein the external electrode is spaced apart from the third surface of the body and perpendicular to the winding axis of the wound portion.

5. The coil component of claim 1,
wherein on a cross-section perpendicular to the first direction, a ratio of a width of the wound portion in the second direction to a width of the body in the second direction is ⅓ or more.

6. The coil component of claim 1,
wherein a ratio of a length of the lead-out portion to a distance between the third surface and the fourth surface of the body is 1/7 or more and ¼ or less.

7. The coil component of claim 6, wherein the external electrode is spaced apart from each of the third surface and the fourth surface of the body.

8. The coil component of claim 7,
wherein the external electrode is spaced apart from each of the first surface and the second surface of the body.

9. The coil component of claim 1, wherein the external electrode includes first and second external electrodes spaced apart from each other disposed on the sixth surface of the body.

10. The coil component of claim 1, wherein the mold portion includes a groove portion configured to accommodate the lead-out portion on a side surface of the base portion.

11. The coil component of claim 10, wherein the groove portion is formed in a direction parallel to the winding axis of the wound portion.

12. The coil component of claim 10, wherein the lead-out portion is disposed between the groove portion and the external electrode.

13. The coil component of claim 10, wherein the sixth surface of the body includes a side surface of the mold portion and a side surface of the cover portion.

14. The coil component of claim 10, wherein the external electrode is in contact with the mold portion and the cover portion.

15. The coil component of claim 1, wherein the core of the mold portion is disposed in a central portion of the base portion and configured to be in contact with the cover portion.

16. The coil component of claim 15, wherein the base portion has inclination on one surface in contact with the cover portion, such that a distance between one surface and the other surface of the base portion opposing each other increases from a central portion of the base portion toward an external side.

17. The coil component of claim 16, wherein the connection portion extends from the wound portion along inclination of one surface of the base portion to the lead-out portion.

18. The coil component of claim 1, wherein the wound coil is formed of a conductive metal, and a surface of a portion other than a portion in contact with the external electrode is coated with an insulating coating layer.

19. The coil component of claim 1, wherein the external electrode includes a first conductive layer including copper (Cu), a second conductive layer disposed on the first conductive layer and including nickel (Ni), and a third conductive layer disposed on the second conductive layer and including tin (Sn).
